(19) United States
(12) Patent Application Publication
(10) Pub. No.: US 2009/0323236 A1
(43) Pub. Date: Dec. 31, 2009

(54) Semiconductor device

(75) Inventor: Yasuyuki Morishita, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/385,996

(22) Filed: Apr. 27, 2009

(30) Foreign Application Priority Data
Jun. 27, 2008 (JP) 168402/2008

(51) Int. Cl. H02H 9/04

(52) U.S. Cl. 361/56

(57) ABSTRACT

In order to solve a problem in a conventional semiconductor device that improvement of resistance to electrostatic discharge damage or improvement of an area efficiency is severely restricted, there is provided a semiconductor device including: a first protection diode (DP) having an anode which is connected to a signal wire connected to an I/O pad (PAD), and having a cathode which is connected to a power supply wire (VDD); a power clamp circuit (10) connected between the power supply wire (VDD) and a ground wire (GND); a slot in which a set of the I/O pad (PAD) and the first protection diode (DP) is formed; and a power clamp circuit formation region in which the power clamp circuit (10) is formed, in which the power clamp circuit formation region has a side adjacent to a plurality of the slots, and has a width (W2) larger than a width of the slot.

### BACKGROUND OF THE INVENTION

1. Field of the Invention

The present invention relates to a semiconductor device, and more particularly, to a semiconductor device including an electrostatic discharge protection element.

2. Description of the Related Art

Transistors formed in semiconductor devices may lead to breakdown when static electricity is applied thereto from the outside. Such a failure mode is referred to as electrostatic discharge damage. In the semiconductor devices, an electrostatic discharge damage (ESD) protection circuit is provided in the vicinity of an input/output (I/O) pad to thereby improve resistance to the electrostatic discharge damage. The electrostatic discharge protection circuit prevents, when a surge current is applied due to the static electricity, the surge current from reaching an internal circuit by discharging the surge current to the outside in the vicinity of the I/O pad, and prevents an abnormal voltage from being applied to the internal circuit. Recent transistors tend to have lower resistance to the electrostatic discharge damage because of the advanced miniaturization. Accordingly, the performance of the electrostatic discharge protection circuit for preventing breakdown of the semiconductor device is extremely important.

An example of the electrostatic discharge protection circuit is disclosed in U.S. Pat. No. 6,385,021. A block diagram of a semiconductor device 100 described in U.S. Pat. No. 6,385,021 is illustrated in FIG. 6. As illustrated in FIG. 6, the semiconductor device 100 includes I/O circuits 101 to 103, a trigger circuit 104, and resistors R1 to Rn.

The I/O circuit 101 includes an ESD protection circuit 111, an I/O pad 112, an NMOS transistor 123, a PMOS transistor 124, and protection diodes 125 and 126. Note that the structure of the I/O circuits 102 and 103 is the same as that of the I/O circuit 101, and hence a description thereof is omitted. The ESD protection circuit 111 includes an NMOS transistor 121 and a buffer 122. The trigger circuit 104 includes a detection circuit 132 and a buffer 131, and the detection circuit 132 includes a resistance element 133 and a capacitor 134.

The semiconductor device 100 protects the NMOS transistor 123, the PMOS transistor 124, and the internal circuit by using the protection diodes 125 and 126, and the ESD protection circuit 111. In a case where static electricity applied from the I/O pad 112 is a positive surge current, the trigger circuit 104 detects a voltage increase of an ESD bus to generate a trigger signal. The trigger signal is transmitted through a trigger bus to make the NMOS transistor 121 of the ESD protection circuit 111 a conductive state. Thus, the positive surge current is discharged to a ground wire VSS through the protection diode 126 and the ESD protection circuit 111. Further, in a case where static electricity applied from the I/O pad 112 is a negative surge current, the negative surge current is discharged to the ground wire VSS through the protection diode 125.

The semiconductor device 100 is provided with the ESD protection circuits 111 in the vicinity of the respective I/O pads, and therefore a wiring distance between the ESD protection circuit 111 and the I/O pad 112 to which the static electricity is applied is made shorter. With this structure, the surge current is discharged to the ground wire VSS without passing through a long discharge path, whereby wiring resistances (R1 to Rn of FIG. 6) of the ESD bus in the discharge path can be made smaller. Specifically, in the semiconductor device 100, a discharge path exhibiting high efficiency is realized by reducing loss generated in the discharge path of the surge current.

However, in recent years, the semiconductor element has been increasingly miniaturized and thus there is a tendency in which an interval between the I/O pads is made narrower. In such a semiconductor device having a narrow pitch between pads, in a case where the ESD protection circuit is provided to each I/O pad, it is necessary to make the ESD protection circuit small or slender (slender in a depth direction, for example). In the case where the ESD protection circuit is made small, a transistor size of the NMOS transistor 121 is made small, which leads to a problem that discharge performance of the surge current is reduced. Moreover, in the case where the ESD protection circuit is made slender, there arises a problem that an area efficiency of a semiconductor chip is reduced. For that reason, in the semiconductor device described in U.S. Pat. No. 6,385,021, there arises a problem that improvement of resistance to electrostatic discharge damage or improvement of an area efficiency is severely restricted.

### SUMMARY

According to an aspect of the present invention, there is provided a semiconductor device including: a first protection diode having an anode which is connected to a signal wire connected to an input/output pad, and having a cathode which is connected to a power supply wire; a power clamp circuit connected between the power supply wire and a ground wire; a slot in which a set of the input/output pad and the first protection diode is formed; and a power clamp circuit formation region in which the power clamp circuit is formed, in which the power clamp circuit formation region has a side adjacent to a plurality of the slots, and has a width larger than a width of the slot.

According to the semiconductor device of the present invention, the power clamp circuit formation region is adjacent to the plurality of the slots. With such an arrangement of the power clamp circuit formation region, a large size can be ensured for the power clamp circuit formation region without depending on an interval between the input/output (I/O) pads. Specifically, in the semiconductor device according to the present invention, a protection circuit in which the power clamp circuit having high current discharge performance is adjacent to all the slots can be formed.

According to the semiconductor device of the present invention, there can be realized a protection circuit having high surge current discharge performance without depending on the interval between the I/O pads.

### BRIEF DESCRIPTION OF THE DRAWINGS

In the accompanying drawings:

FIG. 1 is a circuit diagram of a semiconductor device according to a first embodiment of the present invention;

FIG. 2 is a conceptual diagram illustrating a protection operation of the semiconductor device according to the first embodiment of the present invention;

FIG. 3 is a schematic diagram illustrating a layout of semiconductor elements of the semiconductor device according to the first embodiment of the present invention;

FIG. 4 is a schematic diagram illustrating a layout of wiring of the semiconductor device according to the first embodiment of the present invention;

FIG. 5 is a circuit diagram of a semiconductor device according to a second embodiment of the present invention; and

FIG. 6 is a circuit diagram of a conventional semiconductor device.

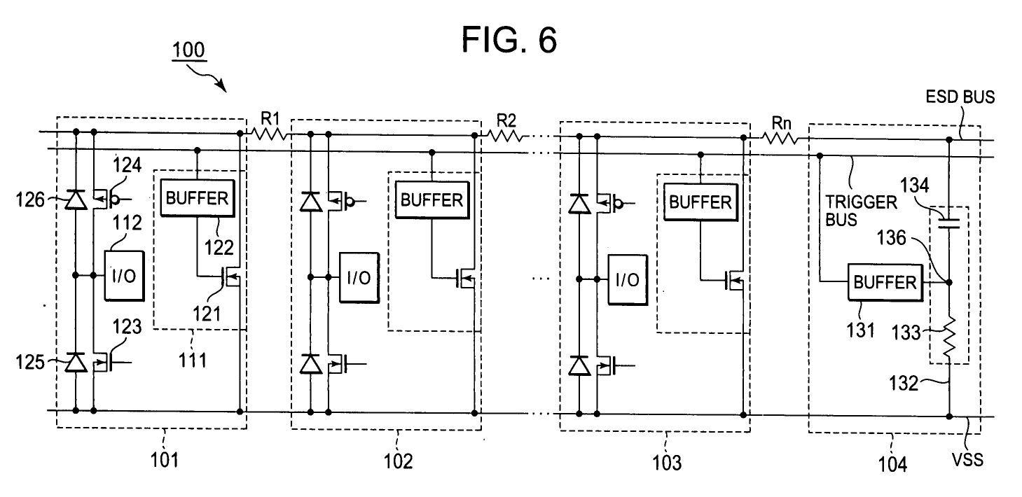

### DETAILED DESCRIPTION OF THE PREFERRED EMBODIMENTS

### First Embodiment

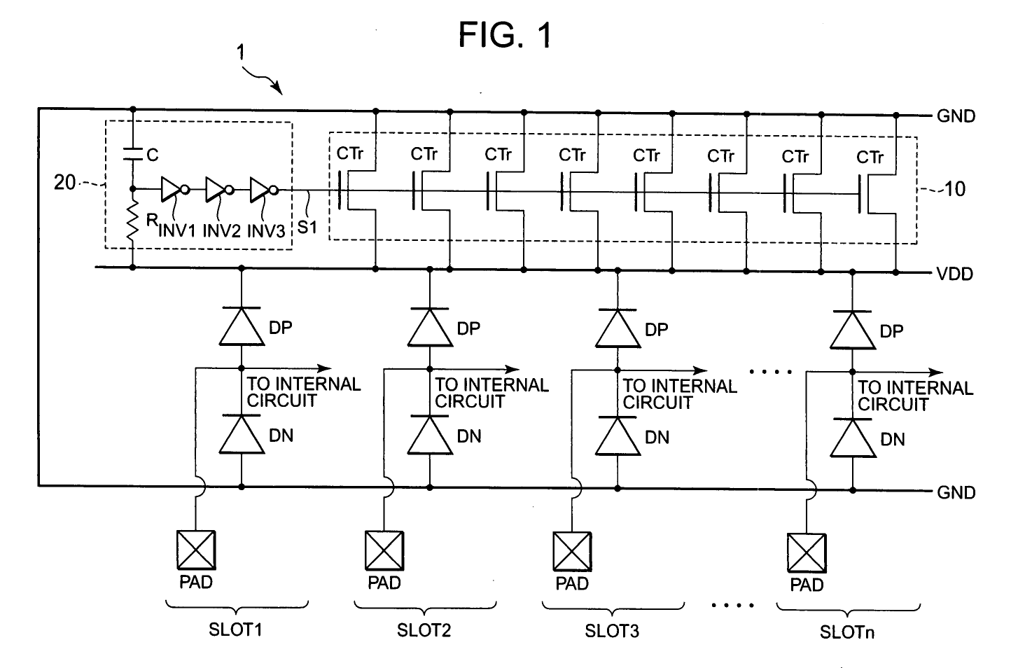

Hereinafter, an embodiment of the present invention is described with reference to the drawings. FIG. 1 is a circuit diagram of a semiconductor device according to the embodiment of the present invention. The circuit diagram of FIG. 1 is a circuit diagram of an input/output (I/O) circuit arrangement region of a semiconductor device 1, and a circuit diagram of an internal circuit is omitted. The semiconductor device 1 includes slots 1 ton, a power clamp circuit 10, a trigger circuit 20, a first power supply wire (power supply wire VDD, for example), and a second power supply wire (ground wire GND, for example).

The slots 1 to n each include an I/O pad PAD, a first protection diode DP, and a second protection diode DN. The I/O pad PAD is an external connection terminal of the semiconductor device 1. A signal wire connected to the internal circuit is connected to the I/O pad PAD, whereby the signal wire is connected to the internal circuit.

The first diode DP is connected at an anode thereof to the signal wire, and at a cathode thereof to the power supply wire VDD. The second diode DN is connected at a cathode thereof to the signal wire and at an anode thereof to the ground wire GND.

The power clamp circuit 10 includes power clamp transistors CTr. FIG. 1 illustrates the power clamp circuit 10 including a plurality of power clamp transistors CTr. In this embodiment, the power clamp transistors CTr are formed as a single transistor. The power clamp transistor CTr is, for example, an NMOS transistor. The power clamp transistor CTr is connected at a source thereof to the ground wire GND and at a drain thereof to the power supply wire VDD. Note that, in this embodiment, the ground wire GND connected to the power clamp transistor CTr and the ground wire GND connected to the second protection diode DN are formed as a single ground wire.

The trigger circuit 20 is connected to the ground wire GND and the power supply wire VDD, and controls operation states of the power clamp circuit 10. For example, when a pulse is generated by static electricity in the power supply wire VDD, the trigger circuit 20 sets a trigger signal S1 to a high level, and the power clamp transistor CTr to be a conductive state.

The trigger circuit 20 includes a resistance element R, a capacitor C, and inverters INV1 to INV3. One terminal of the resistance element R is connected to the power supply wire VDD, and another terminal thereof is connected to one terminal of the capacitor C. Another terminal of the capacitor C is connected to the ground wire GND. A node at which the resistance element R and the capacitor C are connected to each other is connected to an input terminal of the inverter INV1. The inverters INV1 to INV3 are connected in series to each other. The inverters INV1 to INV3 obtain an operation power supply from the power supply wire VDD and the ground wire GND to thereby output a signal obtained by inverting a logic level which is input to the input terminal thereof. Then, an output of the inverter INV3 which is the end stage is the trigger signal S1. The trigger signal S1 is input to a control terminal (gate, for example) of the power clamp transistor CTr.

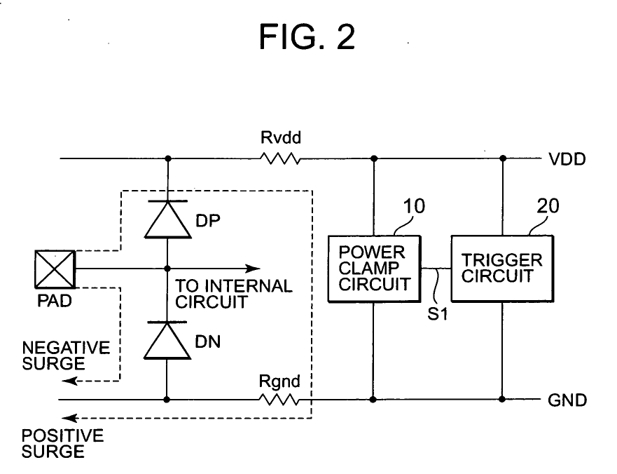

Here, the protection operation in the semiconductor device 1 according to this embodiment is described. FIG. 2 is a conceptual diagram of a circuit of an I/O circuit region of the semiconductor device 1. As illustrated in FIG. 2, a wiring parasitic resistance Rvdd is present in the power supply wire VDD. Further, a wiring parasitic resistance Rgnd is present in the ground wire GND. The power clamp circuit 10 and the trigger circuit 20 are connected to the power supply wire VDD and the ground wire GND.

In such a circuit, when static electricity is applied to the I/O pad PAD, a positive surge current or a negative surge current is generated. In the case where the positive surge current is generated, the trigger circuit 20 sets the trigger signal S1 to a high level, and the power clamp circuit 10 to a conductive state. As a result, the positive surge current is discharged to the ground wire GND through the first protection diode DP, the parasitic resistance Rvdd, and the power clamp circuit 10. In this case, loss occurs in the discharge path of the positive surge current by the parasitic resistance Rvdd. On the other hand, in the case where the negative surge current is generated, the negative surge current is discharged to the ground wire GND through the second protection diode DN.

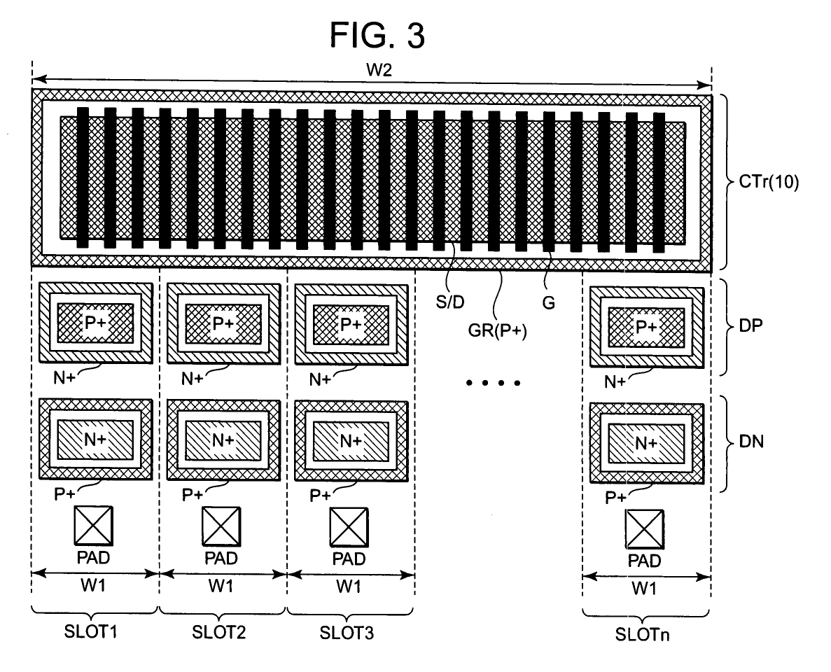

Next, FIG. 3 illustrates an example of a layout of the power clamp transistor CTr and the diodes, which corresponds to the circuit illustrated in FIG. 1. In the example illustrated in FIG. 3, a layout of the elements related to the trigger circuit 20 is not illustrated for the simplification of the drawing. However, the trigger circuit 20 may be formed in the same region as the power clamp circuit 10, or may be formed in a different region.

As illustrated in FIG. 3, in the semiconductor device 1, the slots each include the I/O pad PAD, the first protection diode DP, and the second protection diode DN. The first protection diode DP has a form in which a periphery of a p+ diffusion region (p-type semiconductor region) which becomes an anode is surrounded by an n+ diffusion region (n-type semiconductor region) which becomes a cathode. Further, the second protection diode DN has a form in which a periphery of an n+ diffusion region which becomes a cathode is surrounded by a p+ diffusion region which becomes an anode. The first protection diode DP is arranged in a position closer to a power clamp circuit formation region in which the power clamp transistors CTr are formed, than the second protection diode DN and the I/O pad PAD.

Further, the slots are arranged in a row. The protection diodes of the slots adjacent to each other are formed so as to be adjacent to each other through a device isolation region therebetween. In the description below, a width of the slot is denoted by W1.

The power clamp transistors CTr are formed in the power clamp circuit formation region surrounded by a guard ring region GR which is formed as a p+ diffusion region. The power clamp transistors CTr each include source/drain regions S/D and a gate electrode G which are formed by an n+ semiconductor. The gate electrodes G are formed separately from each other, and the plurality of separate gate electrodes G are connected to each other by wiring (not shown) to be connected to the trigger circuit 20 to thereby function as a single gate electrode.

The power clamp circuit formation region is formed so that a plurality of the slots are arranged adjacently to a side of the power clamp circuit formation region. As a result, a width of the power clamp circuit formation region becomes a width W2, which is larger than the width W1 of the slot. In this embodiment, n slots are arranged adjacently to each other in one power clamp circuit formation region, and therefore W2=n×W1 is established.

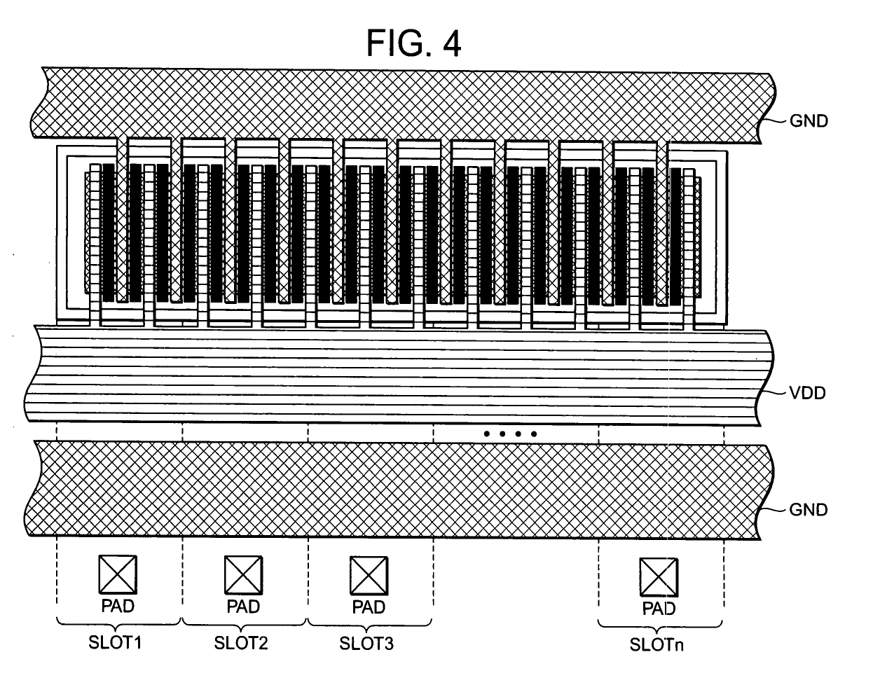

Subsequently, FIG. 4 illustrates an example of a layout of the power supply wire VDD and the ground wire GND, which corresponds to the layout of the elements illustrated in FIG. 3. The ground wire GND connected to the second protection diode DN is formed so as to cover the second protection diode DN. The power supply wire VDD connected to the first protection diode DP is formed so as to cover the first protection diode DP. In FIG. 4, on a lower side of the power clamp transistors CTr, the power supply wire VDD connected to the first protection diode DP is arranged, and on an upper side thereof, the ground wire GND connected to the sources of the power clamp transistors CTr is arranged. The power supply wire VDD has a comb-like wiring portion which is connected to the drains of the power clamp transistors CTr. Further, the ground wire GND has a comb-like wiring portion which is connected to the sources of the power clamp transistors CTr.

Note that the signal wire which connects the I/O pad PAD and the internal circuit is arranged so as not to interfere with the power supply wire VDD and the ground wire GND illustrated in FIG. 4. Moreover, the two ground wires GND illustrated in FIG. 4 are connected to each other in a region other than the regions illustrated in FIG. 4.

As described above, in the semiconductor device 1 according to this embodiment, the power clamp transistors CTr are formed in the power clamp circuit formation region having the side which is adjacent to the plurality of slots. Besides, one power clamp transistor CTr is shared by the plurality of slots. In other words, the power clamp transistors CTr having high discharge performance of the surge current can be formed without restrictions of intervals between the slots (or intervals between the I/O pads PAD). Further, the power clamp transistors CTr are connected to all the slots in a similar manner, whereby all the slots can obtain high protection performance with respect to the static electricity applied to the I/O pads PAD.

Moreover, in a conventional semiconductor device, a power clamp transistor CTr has been formed for each slot. Accordingly, in the conventional semiconductor device, it has been necessary to provide a device isolation region between the power clamp transistors CTr adjacent to each other. On the other hand, in the semiconductor device 1 according to this embodiment, the power clamp circuit formation region is formed so as to straddle the plurality of slots. Specifically, the semiconductor device 1 according to this embodiment does not need a device isolation region between the power clamp transistors CTr which has been necessary in the conventional semiconductor device, and can improve an area efficiency of a semiconductor chip. Further, in the power clamp circuit formation region, the width thereof can be made wider and a length in a depth direction orthogonal to the arrangement direction of the slots can be made shorter. In other words, the semiconductor device 1 according to the present invention can suppress an increase of a circuit area in the depth direction orthogonal to a lateral direction in which the slots are arranged. That is, in the semiconductor device 1 according to the present invention, a larger power clamp transistor CTr having a smaller chip size can be formed in a case of forming a semiconductor chip which is long in the lateral direction in which the slots are arranged.

Further, in the semiconductor device 1 according to this embodiment, the power clamp transistor CTr having high current discharge performance can be formed without depending on the interval between the I/O pads PAD. For example, in a driver circuit of a liquid crystal display device (hereinafter, referred to as liquid crystal display (LCD) driver chip), an enormous number of output terminals are arranged in a row along a side of a semiconductor chip, and intervals between the pads are extremely narrow. Specifically, when the semiconductor device 1 according to this embodiment is applied to a semiconductor chip such as the LCD driver chip, an LCD driver chip having a pad pitch as small as possible can be realized while mounting thereon a power clamp transistor CTr having high current discharge performance. Accordingly, in a case where the semiconductor device 1 according to this embodiment is applied to a semiconductor chip such as the LCD driver chip, an effect of improving the area efficiency in this embodiment becomes more marked.

In addition, in the semiconductor device 1 according to this embodiment, the first protection diode DP connected to the power supply wire VDD is arranged in a position closest to the power clamp circuit formation region in the slot. With this structure, the first protection diode DP and the drains of the power clamp transistors CTr can be connected to each other through extremely short wiring. A wiring distance of the power supply wire VDD which connects the first protection diode DP and the power clamp transistors CTr is made short, and accordingly the parasitic resistance Rvdd of the power supply wire VDD can be extremely made small. That is, the semiconductor device 1 according to this embodiment has an extremely small parasitic resistance Rvdd of a discharge path including the power supply wire VDD, and hence loss in the discharge path can be made extremely small and a discharge path having a high efficiency can be structured.

### Second Embodiment

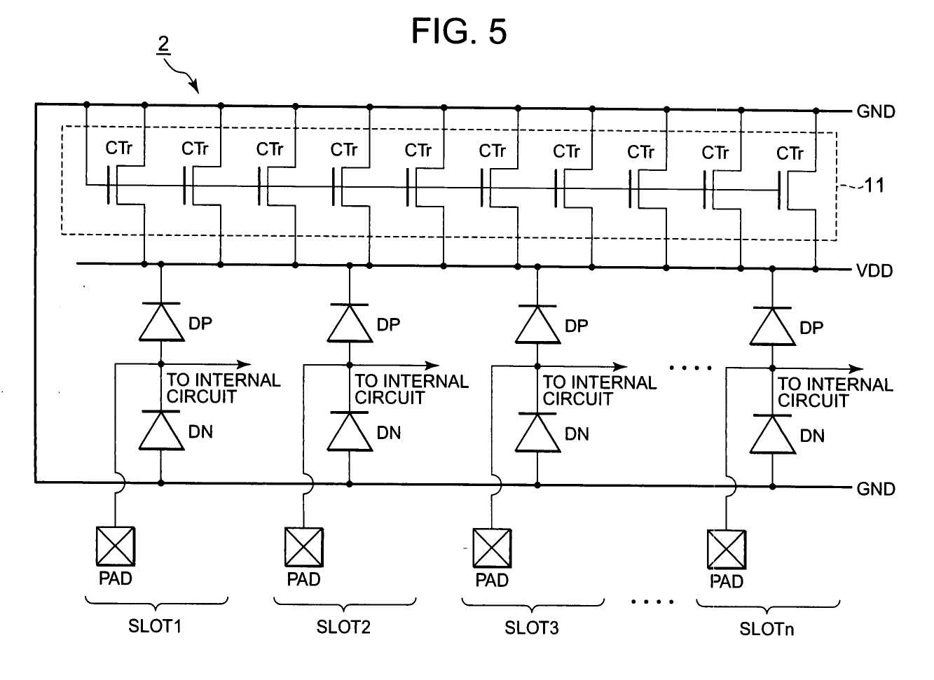

A second embodiment of the present invention is a modification as to a connection destination of the gate of the power clamp transistor CTr. FIG. 5 is a circuit diagram of a semiconductor device 2 according to the second embodiment of the present invention. As illustrated in FIG. 5, the semiconductor device 2 does not include the trigger circuit 20 and includes a power clamp circuit 11 illustrating a modification of the power clamp circuit. The gate of the power clamp transistor CTr in the power clamp circuit 11 is connected to the ground wire GND.

Note that the present invention is not limited to the above-mentioned embodiments, and can be modified without departing from the gist of the present invention.

What is claimed is:

1. A semiconductor device, comprising:
a first protection diode having an anode which is connected to a signal wire connected to an input/output pad, and having a cathode which is connected to a power supply wire;
a power clamp circuit connected between the power supply wire and a ground wire;
a slot in which a set of the input/output pad and the first protection diode is formed; and
a power clamp circuit formation region in which the power clamp circuit is formed,
wherein the power clamp circuit formation region has a side adjacent to a plurality of the slots, and has a width larger than a width of the slot.

2. A semiconductor device according to claim 1, wherein the first protection diode is arranged in a position closest to the power clamp circuit formation region in the slot.

3. A semiconductor device according to claim 1, wherein the first protection diode is adjacent to another first protection diode provided in an adjacent slot of the plurality of the slots through a device isolation region.

4. A semiconductor device according to claim 1, wherein:
the power clamp circuit comprises a power clamp transistor formed in a region surrounded by a guard ring region; and
the guard ring region has a width larger than the width of the slot.

5. A semiconductor device according to claim 4, further comprising a trigger circuit for controlling the power clamp transistor to be a conductive state when abnormality due to static electricity occurs in the input/output pad.

6. A semiconductor device according to claim 4, wherein the power clamp transistor has a control terminal connected to the ground wire.

7. A semiconductor device according to claim 4, wherein the power clamp transistor includes a MOS transistor.

8. A semiconductor device according to claim 1, further comprising a second protection diode formed in the slot and connected between the signal wire and the ground wire.
